(19) United States
(12) Patent Application Publication
(10) Pub. No.: US 2018/0350006 A1
(43) Pub. Date: Dec. 6, 2018

(54) System, Method, and Apparatus for Self-Adaptive Scoring to Detect Misuse or Abuse of Commercial Cards

(71) Applicant: Visa International Service Association, San Francisco, CA (US)

(72) Inventors: Shubham Agrawal, Round Rock, TX (US); Carolina Barcenas, Austin, TX (US); Chiranjeet Chetia, Round Rock, TX (US); Steven Johnson, Lakewood, CO (US); Manikandan Nair, Austin, TX (US)

(21) Appl. No.: 15/612,495

(22) Filed: Jun. 2, 2017

(51) Int. Cl. G06Q 40/00; G06F 7/08; G06F 7/02; G06Q 10/06

(52) U.S. Cl. CPC G06Q 40/12; G06Q 10/067; G06F 7/026; G06F 7/08

(57) ABSTRACT

Provided is a system, method and computer readable medium for detecting at least one non-compliant commercial card transaction for a plurality of transactions received from a merchant, and for generating at least one score for a received transaction, based at least partially on a scoring model, to determine whether a transaction is non-compliant. The scoring model includes at least one score determined by unsupervised learning with feedback from score influencing rules, case disposition data, transactional data, historical data and old scoring models and automatically modifying, at predefined intervals, the scoring model based on current score influencing rules and case disposition data. Machine learning is programmed to score the model based at least partially on a probability-based outlier detection algorithm and a clustering algorithm and to provide a case presentation system for audit and review of scored transactions and to receive input comprising case disposition data and score influencing rules.

### BACKGROUND OF THE INVENTION

### 1. Field of the Invention

This invention relates generally to misuse and abuse detection systems for transactions of commercial cards, and in one particular embodiment, a system, method, and apparatus for self-adaptive scoring to detect misuse or abuse of commercial cards.

### 2. Technical Considerations

Employee misuse and abuse of commercial credit cards is a problem. According to the Association of Certified Fraud Examiners (ACFE), billions are lost every day to employee misuse and abuse. As a result, corporations are seeking new ways to keep misuse/abuse in control and minimize the significant financial risks accompanying such improper uses.

Unlike fraud, misuse and abuse are not usually reported by the cardholders themselves, who are the bad actors. Therefore, the misuse and abuse must be detected independent of the cardholders. Second, the bad actors continually devise new schemes of misuse and abuse of commercial cards, and these new schemes may go unnoticed when no adequate investigative and detection resources are available.

System modeling for detecting misuse or abuse of commercial cards is very difficult. Misuse and abuse detection with analytic processing are important for detecting previously undetected anomalies in company credit card transactional data. However, traditional approaches to misuse and abuse prevention are not particularly efficient. For example, improper payments are often managed by analysts auditing what amounts to only a very small sample of transactions.

Existing commercial card misuse and abuse detection systems and methods employ fixed sets of rules, and are limited to a data intensive task which involves sifting through a multitude of attributes to find new and evolving patterns. In addition, validation of scores is very difficult. Existing models use static rule sets to score cases once a subset of features has been identified.

Further, existing spend management systems have provided travel managers, purchasing managers, finance managers, and card program managers access to online systems to control commercial card purchases. In addition to purchase administration, these systems provide traditional procurement management functions, such as accounting structure support, default coding, split coding, workflow, and direct integration to accounting systems. For example, managers can administer purchases for personal use, company policy, and procedure compliance, and approve of transactions. Adoption of existing systems includes basic reporting, full-feature expense reporting, multinational rollup reporting, and white labeled solutions. For travel accounts, systems include detailed travel data, central travel account support, and full-feature expense reporting with receipt imaging, policy alerts, and approval options.

Accordingly, there is a need in the technological arts for providing systems and methods for updating data models capable of capturing new patterns of misuse and abuse. Additionally, there exists a need in the technological arts for providing systems for improved spend management, out-of-compliance commercial card transaction annotations, past due accounts and overspend monitoring, approval threshold triggers, preferred supplier designation and monitoring, and enhanced regulatory reporting. Finally, a need exists for providing compliance management using critical intelligence assistance for optimal card program management.

### SUMMARY OF THE INVENTION

Accordingly, it is an object of the present invention to provide a system, method, and apparatus for a self-adaptive scoring process to detect misuse or abuse of commercial cards automatically using supervised feedback as well as unsupervised anomaly detection algorithms for refining machine learning anomaly detection algorithms.

According to a non-limiting embodiment, provided is a computer-implemented method for detecting non-compliant commercial card transactions from a plurality of transactions associated with a plurality of merchants, comprising: receiving, with at least one processor, a plurality of settled transactions for commercial cardholder accounts; generating, with at least one processor, at least one score for each settled transaction of the plurality of settled transactions as each settled transaction is received based at least partially on at least one scoring model; determining, with at least one processor, whether each settled transaction is compliant or non-compliant based at least partially on the at least one score for each settled transaction; receiving, with at least one processor from at least one user, case disposition data corresponding to at least one settled transaction of the plurality of settled transactions; and automatically modifying, at predefined intervals, the scoring model based at least partially on heuristics, anomaly scoring and case disposition data.

According to a non-limiting embodiment, provided is a system for detecting at least one non-compliant commercial card transaction from a plurality of transactions associated with a plurality of merchants, comprising at least one transaction processing server having at least one processor programmed or configured to: receive, from a merchant, a plurality of settled transactions for commercial cardholder accounts; generate at least one score for each settled transaction of the plurality of settled transactions as each settled transaction is received based at least partially on at least one scoring model; determine whether each settled transaction is compliant or non-compliant based at least partially on the at least one score for each settled transaction; receive, from at least one user, score influencing heuristics corresponding to at least one settled transaction of the plurality of settled transactions; receive, from at least one user, case disposition data corresponding to at least one settled transaction of the plurality of settled transactions; and automatically modify, at predefined intervals, the scoring model based at least partially on the heuristics, anomaly detection and case disposition data.

According to a further non-limiting embodiment, provided is a computer program product for processing non-compliant commercial card transactions from a plurality of transactions associated with a plurality of merchants, comprising at least one non-transitory computer-readable medium including program instructions that, when executed by at least one processor, cause the at least one processor to: receive, from a merchant point of sale system, a plurality of settled transactions for commercial cardholder accounts; generate at least one score for each settled transaction of the plurality of settled transactions as each settled transaction is received based at least partially on at least one scoring model; determine whether each settled transaction is compliant or non-compliant based at least partially on the at least one score for each settled transaction; receive, from at least one user, score influencing heuristics corresponding to at least one settled transaction of the plurality of settled transactions; receive, from at least one user, case disposition data corresponding to at least one settled transaction of the plurality of settled transactions; and automatically modify, at predefined intervals, the scoring model based at least partially on the heuristics and case disposition data.

Further embodiments or aspects are set forth in the following numbered clauses:

Clause 1: A computer-implemented method for detecting non-compliant commercial card transactions from a plurality of transactions associated with a plurality of merchants, comprising: receiving, with at least one processor, a plurality of settled transactions for commercial cardholder accounts; generating, with at least one processor, at least one score for each settled transaction of the plurality of settled transactions as each settled transaction is received based at least partially on at least one scoring model; determining, with at least one processor, whether each settled transaction is compliant or non-compliant based at least partially on the at least one score for each settled transaction; receiving, with at least one processor from at least one user, case disposition data corresponding to at least one settled transaction of the plurality of settled transactions; and automatically modifying, at predefined intervals, the scoring model based at least partially on heuristics and case disposition data.

Clause 2: The computer-implemented method of clause 1, wherein the at least one scoring model is based at least partially on at least one of a probability-based outlier detection algorithm and a clustering algorithm.

Clause 3: The computer-implemented method of clauses 1 and 2, wherein receiving the case disposition data comprises: generating at least one graphical user interface comprising at least a subset of the plurality of settled transactions; and receiving user input through the at least one graphical user interface, the user input comprising the case disposition data.

Clause 4: The computer-implemented method of clauses 1-3, wherein generating the at least one score for each settled transaction of the plurality of settled transactions as each settled transaction is received comprises generating the at least one score for a subset of settled transactions on a daily basis or on a real-time basis.

Clause 5: The computer-implemented method of clauses 1-4, further comprising receiving, with at least one processor from the at least one user, at least one score influencing rule corresponding to at least one settled transaction of the plurality of settled transactions, wherein the scoring model is modified based at least partially on the at least one score influencing rule.

Clause 6: The computer-implemented method of clauses 1-5, receiving by a case presentation server the score influencing rule, wherein the score influencing rule is assigned to a first company.

Clause 7: The computer-implemented method of clauses 1-6, further comprising in response to generating at least one score for each settled transaction, determining with at least one processor, reason codes that communicate information about a particular scored feature.

Clause 8: The computer-implemented method of clauses 1-7, further comprising in response to generating at least one score for each settled transaction, determining with at least one processor, reason codes that communicate information about a particular scored feature, wherein a contribution to the score is indicated by the reason code.

Clause 9: The computer-implemented method of clauses 1-8, wherein the clustering algorithm is processed first, providing at least one scored settled transaction before the at least one probability-based outlier detection algorithm.

Clause 10: The computer-implemented method of clauses 1-9, further comprising feedback for model scoring, the feedback including at least one of score influencing rules, case dispositive data, old model scores, and new historical data.

Clause 11: The computer-implemented method of clauses 1-10, wherein the feedback updates at least one attribute associated with a scored transaction.

Clause 12: A system for detecting at least one non-compliant commercial card transaction from a plurality of transactions associated with a plurality of merchants, comprising at least one transaction processing server having at least one processor programmed or configured to: receive, from a merchant, a plurality of settled transactions for commercial cardholder accounts; generate at least one score for each settled transaction of the plurality of settled transactions as each settled transaction is received based at least partially on at least one scoring model; determine whether each settled transaction is compliant or non-compliant based at least partially on the at least one score for each settled transaction; receive, from at least one user, score influencing heuristics corresponding to at least one settled transaction of the plurality of settled transactions; receive, from at least one user, case disposition data corresponding to at least one settled transaction of the plurality of settled transactions; and automatically modify, at predefined intervals, the scoring model based at least partially on the heuristics and case disposition data.

Clause 13: The system of clause 12, wherein the at least one processor is further programmed or configured to score the at least one model based at least partially on at least one of a probability-based outlier detection algorithm and a clustering algorithm.

Clause 14: The system of clauses 12 and 13, wherein the at least one processor is further programmed or configured to: generate at least one graphical user interface comprising at least a subset of the plurality of settled transactions; and receive user input through the at least one graphical user interface, the user input comprising the case disposition data.

Clause 15: The system of clauses 12-14, wherein the at least one processor is further programmed or configured to generate at least one score for each settled transaction of the plurality of settled transactions as each settled transaction is received, comprising generating the at least one score for a subset of settled transactions on a daily basis or on a real-time basis.

Clause 16: The system of clauses 12-15, wherein the at least one processor is further programmed or configured to receive, with at least one processor from the at least one user, at least one score influencing rule corresponding to at least one settled transaction of the plurality of settled transactions, wherein the scoring model is modified based at least partially on the at least one score influencing rule.

Clause 17: The system of clauses 12-16, wherein the score influencing rule is assigned to a first company, the score influencing rule.

Clause 18: The system of clauses 12-17, wherein the at least one processor is further programmed or configured to in response to generating at least one score for each settled transaction, determine with at least one processor, reason codes that communicate information about a particular scored feature, wherein a contribution to the score is indicated by the reason code.

Clause 19: The system of clauses 12-18, wherein the at least one processor is further programmed or configured to process the clustering algorithm first, providing at least one scored settled transaction, before at least one probability-based outlier detection algorithm is processed.

Clause 20: The system of clauses 12-19, wherein the at least one processor is further programmed or configured to include at least one or more score influencing rules, case dispositive data, old model scores, and new historical data.

Clause 21: The computer-implemented method of clauses 12-20, wherein the feedback updates at least one attribute associated with a scored transaction.

Clause 22: A computer program product for processing non-compliant commercial card transactions from a plurality of transactions associated with a plurality of merchants, comprising at least one non-transitory computer-readable medium including program instructions that, when executed by at least one processor, cause the at least one processor to: receive, from a merchant point of sale system, a plurality of settled transactions for commercial cardholder accounts; generate at least one score for each settled transaction of the plurality of settled transactions as each settled transaction is received based at least partially on at least one scoring model; determine whether each settled transaction is compliant or non-compliant based at least partially on the at least one score for each settled transaction; receive, from at least one user, score influencing heuristics corresponding to at least one settled transaction of the plurality of settled transactions; receive, from at least one user, case disposition data corresponding to at least one settled transaction of the plurality of settled transactions; and automatically modify, at predefined intervals, the scoring model based at least partially on the heuristics and case disposition data.

### BRIEF DESCRIPTION OF THE DRAWINGS

Various ones of the appended drawings merely illustrate example embodiments of the present disclosure and cannot be considered as limiting its scope.

FIG. 1 is a schematic diagram for a system for generating a scoring model according to the principles of the present invention;

FIG. 2 is a schematic diagram for a system for generating and processing a scoring model according to the principles of the present invention;

FIG. 3A is a process flow diagram for unsupervised machine learning clustering algorithms according to the principles of the invention;

FIG. 3B is a cluster diagram showing three exemplary clusters of plotted transactions according to the principles of the invention;

FIG. 4 is a process flow diagram for unsupervised anomaly detection using probabilities according to the principles of the invention;

FIG. 5 is a schematic diagram for a system for processing and reviewing at least one scored non-compliant commercial card transaction according to the principles of the present invention;

FIG. 6 is a timeline schematic diagram illustrating the timing of an adaptive scoring system and method employing feedback according to the principles of the present invention;

FIG. 7 is a process flow diagram for generating and processing at least one merchant redemption voucher according to the principles of the present invention; and

FIG. 8 is a process flow diagram for refreshing a scoring model according to the principles of the present invention.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

Non-limiting embodiments of the present invention are directed to a system, method, and computer program product for detecting at least one misuse or abuse of a commercial card during a commercial card transaction associated with a company or institution. Embodiments of the invention allow for a self-adaptive refinement of scoring rules defined using feedback provided by supervised learning from account owners, supervised scoring rules, and dispositive data. In a non-limiting embodiment of the invention, the system makes use of the known and available misuse and abuse data to learn using machine learning algorithms to find new patterns and generate more accurate reason codes. The scores and codes become more accurate when the available data is used to make new determinations. Rather than waiting for human intervention to update the rules gradually, non-limiting embodiments may include supervised learning, comprising case information, score influencing rules, and transactional updates, some based on previous score models, to form new scoring models at a predetermined time. The self-adaptive refresh causes the scoring algorithm to predict new anomalies by eliminating old cases that could unduly influence new rules or contain false-positive commercial card transactions.

As used herein, the term “commercial card” refers to a portable financial device issued to employees or agents of a company or institution to conduct business-related transactions. A commercial card may include a physical payment card, such as a credit or debit card, or an electronic portable financial device, such as a mobile device and/or an electronic wallet application. It will be appreciated that a commercial card may refer to any instrument or mechanism used to conduct a transaction with an account identifier tied to an individual and a company or institution.

As used herein, the terms “misuse” and “abuse” refer to the characterization or classification of a transaction based on predictions using attributes of the associated data to determine the nature of a transaction. Abuse may refer to intentionally or unintentionally violating policies and procedures for personal gain. Misuse may refer to the unauthorized purchasing activity by an employee or agent to whom a commercial card is issued. Misuse may comprise a wide range of violations, varying in the degree of severity, from buying a higher quality good than what is deemed appropriate to using non-preferred suppliers. The term “fraud” may refer to the unauthorized use of a card, resulting in an acquisition whereby the end-user organization does not benefit. Fraud may be committed by the cardholder, other employees of the end-user organization, individuals employed by the supplier, or persons unknown to any of the parties involved in the transaction.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “merchant point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction. A merchant POS system may also include one or more server computers programmed or configured to process online payment transactions through webpages, mobile applications, and/or the like.

As used herein, the term “supervised learning” may refer to one or more machine learning algorithms that start with known input variables (x) and an output variable (y), and learn the mapping function from the input to the output. The goal of supervised learning is to approximate the mapping function so that predictions can be made about new input variables (x) that can be used to predict the output variables (y) for that data. The process of a supervised algorithm learning from the training dataset can be thought of as a teacher supervising the learning process. The correct answers are known. The algorithm iteratively makes predictions on the training data and is corrected by the teacher. Learning stops when the algorithm achieves an acceptable level of performance. Supervised learning problems can be further grouped into regression problems and classification problems. Supervised learning techniques can use labeled (e.g., classified) training data with normal and outlier data, but are not as reliable because of the lack of labeled outlier data. For example, multivariate probability distribution based systems are likely to score the data points with lower probabilities as outliers. A regression problem is when the output variable is a real value, such as “dollars” or “weight”. A classification problem is when the output variable is a category, such as “red” and “blue,” or “compliant” and “non-compliant”.

As used herein, the term “unsupervised learning” may refer to an algorithm which has input variables (x) and no corresponding output variables. The goal for unsupervised learning is to model the underlying structure or distribution in the data in order to learn more about the data. Unlike supervised learning, in unsupervised learning there are no correct answers and there is no teacher. Unsupervised learning algorithms are used to discover and present the interesting structure in the data. Unsupervised learning problems can be further grouped into clustering and association problems. A clustering problem is modeling used to discover the inherent groupings in a dataset, such as grouping customers by purchasing behavior. An association rule learning problem is where you want to discover rules that describe large portions of data, such as people that buy A also tend to buy B. Some examples of unsupervised learning algorithms are clustering and likelihood modeling.

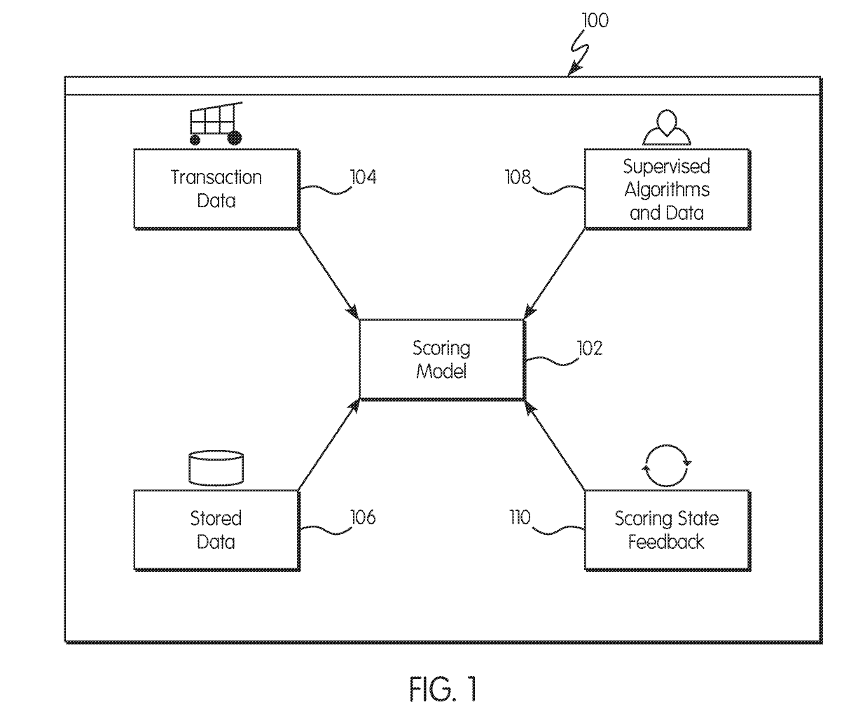

Referring now to FIG. 1, a dynamic scoring system 100 for detecting misuse and abuse is shown according to a preferred and non-limiting embodiment. A scoring model 102 may include, for example, one or more self-adaptive state feedbacks from the system 100. The system 100 may generate one or more trends in commercial card transaction data to identify anomalies that may indicate abuse or misuse. The system 100 may analyze, for example, one or more commercial cardholder transactions for the purpose of making payments for various goods, services, and business expenses, where the type of misuse and abuse is not the type found in commercial card fraud detection systems. The cardholder may be an employee of a company to whom a commercial card is issued for the purpose of making designated business purchases/payments on behalf of their organization.

In a non-limiting embodiment of the scoring system 100 shown in FIG. 1, commercial card transaction records are tested using machine learning algorithms processed on specially programmed computers for identifying corporate card misuse and abuse cases. The scoring model 102 is self-adaptive, receiving communications comprising card transaction records merged from one or more card transaction data 104, stored data 106, and heuristics and dispositive data 108 from commercial card management systems. Scoring state feedback 110 represents the self-adaptive learning aspect, using new and historic attributes to refresh the model scoring. The historic attributes are determined from dispositive data and rules, both influencing the model scoring.

With continued reference to FIG. 1, the scoring model 102 may create score rules for scoring incoming commercial cardholder transactions. In a non-limiting embodiment of the invention, the scoring rules are defined once a month and used to score daily new transactions. The scores may refer to tags or other indicators of information and are assigned as an attribute of the record. During the process of creating the scoring model 102, the system 100 performs data model training where the scoring algorithm learns from training data. The term data model refers to the model artifact, the scoring model that is defined by the training process. The training data must contain the correct answer, which is known as a target or target attribute. The learning algorithm identifies patterns in the training data that map the input data attributes to the target (e.g., the answer to predict), and it outputs the scoring model that captures these patterns.

The commercial card transaction data 104 may refer to standard transaction data and may include, for example, transaction date, transaction time, supplier, merchant, total transaction value, customer-defined reference number (e.g., a purchase order number, separate sales tax amount), and/or line-item detail, such as the item purchased. The stored commercial data 106 may include data that can be associated with a transaction by comparing key identifying fields that may include, for example, one or more of name, cardholder ID, merchant ID, or Merchant Category Code (MCC). In non-limiting embodiments, such matching may incorporate data from existing tables and may include, for example, one or more of lodging data, case data, car rental data, and/or account balance data. Heuristics and dispositive data 108 may refer to rules that are based on user inputs during a review, which each company in the system will have the capability to create for influencing score values based on certain criteria. For example, it will be appreciated that if MCC has a value of 5812 (fast food) and the amount is less than $5, the score may be in the low range (indicating a proper transaction) across most commercial systems. If the amount is over $100, the transaction may be considered abnormal for the purposes of lunchtime fast-food purchase. Such a rule, and others of similar and increasing complexity, may be stored in the system 100 and may characterize transactions when processed. The rules are statements that include one or more identifying clauses of what, where, who, when, and why a certain transaction should be influenced.

The score influencing rules may also further refine or adjust the dataset scores in the set. Parameters of an old score model may be added to the model data. The old unsupervised scoring model may be used to score elements of the dataset to assign score rules to features of the data and create more attributes in the data. A query processor may be configured to update historical data with provisions about cases based on dispositive tagging by an end-user and score influencing rules for tagging records. The system includes a case presentation application for receiving communications for entering, updating, copying, and changing rules and tagging or scoring records. Case dispositive data, or a decision matrix, indicates information about a case, such as tagging, to show explicitly that a case is ‘good,’ ‘misuse,’ ‘abuse,’ and/or ‘fraud.’ The labels can be used before modeling to remove abusive transactions from the model data before running unsupervised algorithms.

In one non-limiting embodiment, the scoring state feedback 110 may refer to a process of dynamically shaping the scores based on feedback from the data and input sources. The state of the dynamic scoring system 100 is based on a collection of variables or attributes that permit detection of new anomalies. Such incremental changes in the system are entered into the scoring algorithms. The incremental changes in such attributes can have powerful effects during the training of new model scores. They may be defined by differences introduced in the state of the system. The incremental changes may refer to changes in commercial data, updated or new case dispositive or influencing rules, and new transaction data. The feedback may affect or influence the features of the model.

The scoring model 102, in response to receiving a model data set, generates predictions on new raw data for which the target is not known. For example, to train a model to predict if a commercial card transaction is a misuse or abuse, training data is used that contains transactions for which the target is known (e.g., a label that indicates whether a commercial card transaction is abused or not abused). Training of a model is accomplished by using this data, resulting in a model that attempts to predict whether new data will be abuse/misuse or not.

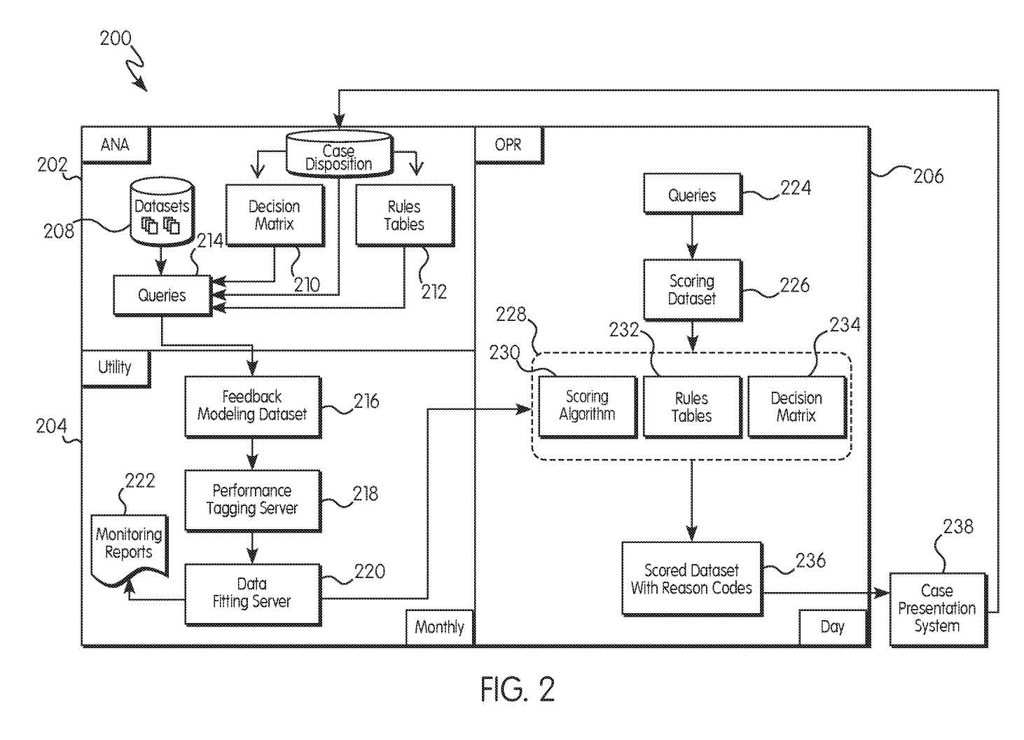

Referring now to FIG. 2, a commercial card scoring system 200 is provided for processing self-adaptive scoring model updates according to a preferred and non-limiting embodiment. The system implements scoring datasets in a scalable commercial card scoring system 200, processing large volumes of commercial card transaction data. The system 200 comprises data services 202, utility 204, and operations 206. The data services 202 communicate with processes to transfer the data stores of a commercial data repository 208, a decision matrix 210, and a pre-configured ruleset 212. The data stores in a non-limiting embodiment are transformatively coupled to operations for dynamically modifying, refreshing, and/or updating the score rules. The score rules may be converted by operations into a scoring algorithm such as feature trees with associated reason codes. In addition, the data services 202 includes queries 214, including stored SQL transformations, data provisioning procedures, and other transformations.

With continued reference to FIG. 2, data services 202 store received transaction data and historical data. The transaction data may be matched and provisioned with commercial data stored in the historical data scoring system 200. The data services 202 may include an arrangement of transformations with a purposed or aligned functionality. The queries 214 may include, for example, one or more libraries comprising basic SQL transformations, data provisioning using transformations which are customized for specialized parameters, table comparison, history preservation, lookups, and predictive analysis libraries. The libraries may include one or more transformations which are used for analysis or predictive analysis, business functions, and transformations which are of special use to generate a scoring model for handling data, e.g., transaction data, case dispositions, other sources, and/or the like. Data services 202 provide access for services on a database warehouse platform such as, for example, data cubes.

With continued reference to FIG. 2, a modeling dataset 216 is received from the data services 202. The data services 202 provide transformations of the data and may perform one or more map reducing processes to load only the new and changed data from the data sources. The modeling data set 216 communicates to a performance tagging server 218 compliant cases that are tagged with additional information and non-compliant cases which are raw data and not tagged. The configuration files are based on inputs during a compliance review session. The configuration files can include, for example, one or more supervised decision matrix 210 having case dispositive information and pre-configured rulesets 212. These supervised learning labels and rules may define or refer to policies for each company using the system 200 and will have influencing rules that influence score values based on certain criteria. For example, if MCC is 5812 and the amount is less than $5, the score would be low, compliant, or good.

Still referring to FIG. 2, the performance tagging server 218 performs automatic tagging (e.g., labeling) of the raw data based on detected anomalies in a machine learning process. The performance tagging server 218 also performs anomaly detection defined by supervised learning feedback. The modeling dataset 216 is pulled from datasets 208 for the performance tagging server 218. The performance tagging server 218 enables data federation, replication, and transformation scenarios for local or in-cloud deployment and for connectivity to remote sources. Performance tagging may be defined as automatic machine or computer-implemented tagging of records without human intervention. Data tagging or labeling is defined by adding data tags to data based on attributes of the data. Data tags are labels attached to a field in a record for the purpose of identification or to give additional information about a record. Data tags can be used to categorize or segment the data based on various criteria or to facilitate management of vast amounts of data. The data can be extracted, sorted, processed, transmitted, or moved based on these segments.

Utility processing 204 includes the training process, which fit the scoring model with data to create the scoring algorithms. Data training server 220, which generates score rules defined by the scoring model using training data, includes one or more feature values for entity classification, and associates each entity with one or more classifiers. The training server may build the model scores using at least the data training server 220 for a gradient boosting system that applies a machine learning process that can be used to build scoring models including one or more of sub-models. For example, each of the one or more sub-models can be decision trees. Candidate features of the trees are defined by normalized transactional data, lodging data, case data, rules data, account level aggregates, transaction history, and/or balance data. The training data includes compliant transactions and/or one or more raw non-compliant transactions. The features of the data are determined using processes for unsupervised machine learning. The final mode being delivered is a decision tree. The model scoring training builds a scoring algorithm using gradient boosting trees. In addition, reason codes may be determined by estimating feature importance in each tree. The estimated feature contribution in the scores of each terminal node is used to generate the reason codes. A clustering method and likelihood model are built using the training data and a record's outlier-ness is tested against it. In a non-limiting embodiment, the machine learning can be run in sequence, with the clustering running twice, and then using likelihood modeling after the clustering training.

During the implementation phase, the score rules are used to process incoming transactions for detection of misuse and abuse. Monitor reports 222 can be used to transfer analytic knowledge. A second set of queries 224, similar to the queries 214, are used to generate a dataset 226. The dataset 226 may be scored by one or more of a decision matrix 234 and preconfigured rules 232. A scoring engine 228 processes the scoring dataset 226 using the score influencing rules, the decision matrix 234, and the scored dataset 236. As cases are scored, they are communicated to a case management server.

Unlike fraud detection for regular consumer credit cards, not all misuses and abuses can be easily detected. Unsupervised machine learning techniques have been adopted to capture new and undetected trends automatically. Prediction systems provide predictive analysis that utilizes past and present data to detect questionable transactions. The system uses advanced analytic techniques, such as machine learning, to identify new areas of risk and vulnerability.

Machine learning may refer to a variety of different computer-implemented processes that build models based on a population of input data by determining features of the entities within the population and the relationships between the entities. To build the model, the machine learning process can measure a variety of features of each entity within the population, and the features of different entities are compared to determine segmentations. For example, a machine learning process can be used to cluster entities together according to their features and the relationships between the entities.

As used herein, the terms “classifier” and “classification label” refer to a label (e.g., tag) describing an attribute of an entity. A classifier may be determined by a human or dynamically by a computer. For example, a person may classify a particular transaction as ‘good,’ ‘misuse,’ ‘abuse,’ and/or ‘fraud.’ In another example, transactions may be classified based on what type of goods or services are purchased (e.g., “food” or “hotel”) or other details of the transactions. One or more classification labels may be applied to each entity. Entities having the same classification label may have one or more features having similar values.

As used herein, the term “features” refers to the set of measurements for different characteristics or attributes of an entity as determined by a machine learning process. As such, the features of an entity are characteristic of that entity such that similar entities will have similar features depending on the accuracy of the machine learning process. For example, the “features” of a transaction may include the time of the transaction, the parties involved in the transaction, or the transaction value. In addition, the features of a transaction can be more complex, including a feature indicating the patterns of transactions conducted by a first party or patterns of the other parties involved in a transaction with the first party. The features determined by complex machine learning algorithms may not be able to be interpreted by humans. The features can be stored as an array of integer values. For example, the features for two different entities may be represented by the following arrays: [0.2, 0.3, 0.1, . . . ] for the first entity and [0.3, 0.4, 0.1, . . . ] for the second entity. Features such as bench-marking statistics (e.g., mean dollar per MCC) may be calculated for the company or institution and/or card-type.

The data services 202 include, for example, at least one or more volumes of data that are related to a transaction. Once in the system, the data is stored and used in the normal course of business. In addition, the data services 202 are able to match records with transactions. Data that does not conform to the normal and expected patterns are called outliers. Outliers can involve a wide range of commercial transactions involving various aspects of a purchase transaction. The system stores large amounts of data, which may be unstructured, creating the opportunity to utilize big data processing technologies. Unstructured data may refer to raw data that has not been tagged.

The modeling approach segments data into groups based on attributes of the data. The groups are defined by attributes and differing combinations of attributes, such as card-type (e.g., purchase card or travel card), transaction type, or company type. In addition, the transactions may be segmented based on MCG, MCC, airline, hotel chain, car rental, demographic information, business unit, supplier location, cardholder state, cardholder country, transaction type, amount, supplier country, and/or supplier country and city.

As an example, detections may determine, for company A, that most of the commercial card users pay approximately $25.00 for lunch. The determination may be used to detect lunch transactions outlying typical lunch transactions by calculating the mean and standard deviation. Transactions diverging from the standard deviation could be determined to be an instance of abuse or possible abuse. In one aspect of the invention, a rule could be programmed to compare records that deviate and report them as possible abuse. A transaction time combined with an MCC may be used to determine that the transaction is for lunch, and therefore that the transaction should be compared with typical lunch transactions.

A location attribute may indicate a location from which a transaction originates. For example, the attribute “City” may indicate “Paris” or “New York.” Other dimensions available include one or more of MCC occurrence rate, lodging data, case data, car rental data, and/or account balance data. Each transaction processed by the data scoring system 200 is assigned an MCC, a four-digit number that denotes the type of business providing a service or selling merchandise. The MCC for dating and escort services is 7273, and for massage parlors it is 7297. The table below shows several exemplary MCC codes which are used in the system:

TABLE 1

| MCC | Merchant Category Code |
|---|---|
| 3000-3299 | Airlines |
| 4511 | Airlines, Air Carriers |
| 5542 | Automated Fuel Dispensers |
| 5811 | Caterers |
| 5812 | Eating Places, Restaurants |
| 5813 | Drinking Places |
| 5814 | Fast Food Restaurants |
| 5912 | Drug Stores and Pharmacies |
| 5921 | Package Stores-Beer, Wine, and Liquor |
| 6011 | Automated Cash Disburse |
| 7011 | Hotels, Motels, and Resorts |
| 5931 | Used Merchandise and Secondhand Stores |

The MCC may be used, for example, to monitor one or more aspects of and restrict spending on commercial cards. The MCCs, along with the name of the merchant, give card issuers an indication of cardholders' spending. The system can use MCCs for many different rules. In embodiments, a rating of MCCs could distinguish between common and rare merchant categories, or any range between. Rare MCCs may be scored as possible misuse and abuse.

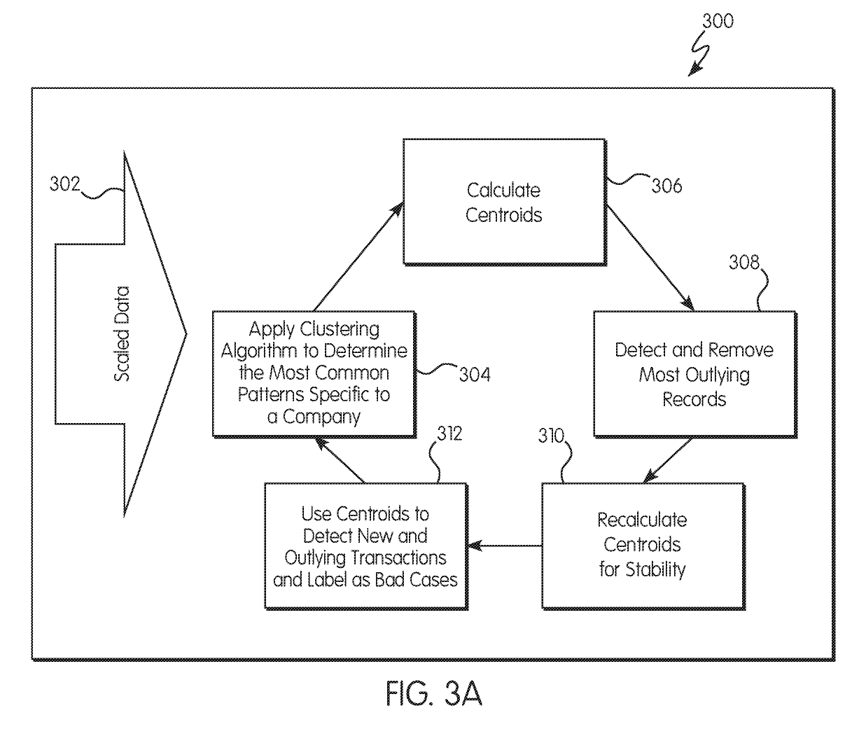

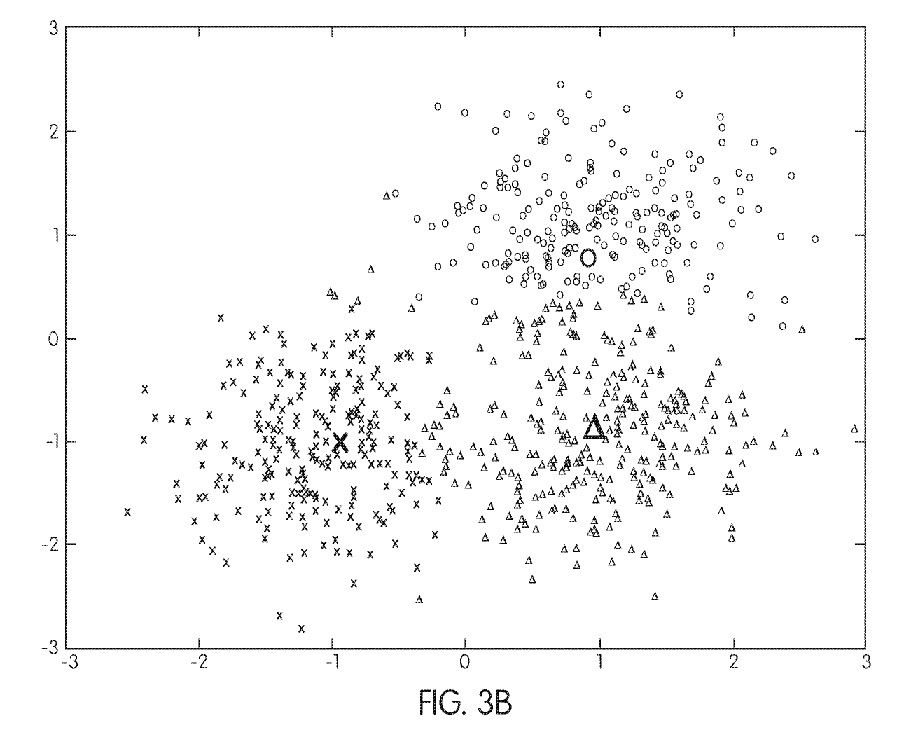

FIG. 3A is a flow chart 300 of a clustering method of the present invention for detecting new outlying transactions using a clustering algorithm. The goal of clustering is to find common patterns and to score them low. Cluster analysis is used for exploratory data analysis to identify hidden patterns or groupings in data. In a non-limiting embodiment, the goal of the clustering is to mine transactions with common patterns and score them low. For example, a restaurant purchase of approximately $25-$50 may be common for a company and scored low for all transactions having similar attributes, but larger amounts may be identified when compared. Clustering can be regarded as a form of classification in that it can be used to create a classification of objects with classification labels. However, unsupervised anomaly detection algorithms use only intrinsic information of the data in order to detect instances deviating from the majority of the data to derive classification labels. This is in contrast to supervised classification, where new, unlabeled objects are assigned a classification label using a model developed from objects with known classification labels.

With continued reference to FIG. 3A, transactions that are not scored low, or are generally outside a range of the cluster for a particular pattern, can be identified as possible outliers. At step 302, scaled data is communicated to the clustering process. Feature scaling is a method used to standardize the range of independent variables or features of data. Such data normalization techniques may be performed during the data preprocessing step. Since the range of values of raw data varies widely, in some machine learning algorithms objective functions may not work properly without normalization. For example, the classifiers calculate the distance between two points by the Euclidean distance. If one of the features has a broad range of values, the distance will be governed by this particular feature. Therefore, the range of all features should be normalized so that each feature contributes approximately proportionately to the final distance. The scaling factors may refer to predefined scaling thresholds.

Still referring to FIG. 3A, the clustering algorithm is then applied to determine the most common patterns specific to a company. In a non-limiting embodiment, at step 304, a K-mean algorithm is used. Other types of clustering may also be used, such as density clustering or hierarchical clustering. However, K-means algorithms store K-centroids for defining clusters. A point is considered to be in a particular cluster if it is closer to that cluster's centroid than any other centroid. The clustering algorithm finds the best centroids by alternating between (1) assigning data points to clusters based on the current centroids and (2) choosing centroids (points which are the center of a cluster) based on the current assignment of data points to clusters. Determination of the initial centroids is made at step 304. The number of centroids, K, may be user specified or pre-determined by the system. The K initial centroids are identified from the larger group of points. The points can be chosen randomly or using other techniques that preserve randomness but also form well separated clusters.

With continued reference to FIG. 3A, at step 306, the centroids are determined for a group of points. The clusters are formed by assigning each point in the group of points to its closest centroid. To assign a point to the closest centroid, proximity may be used to determine the measurements between points and the centroid. At step 308, the outlying records of the generated centroids are detected and removed. Outliers can unduly influence the clusters that are found. In particular, when outliers are present, the resulting cluster centroids may not be as representative as they otherwise would be and, thus, the sum of the squared error will be higher as well. Because of this, it is often useful to discover outliers and eliminate them beforehand.

At step 310 in FIG. 3A, the centroids are recalculated for stability. Each recalculation causes further convergence of the clusters. The recalculation may generate a new centroid and, in some embodiments, the centroid moves closer to the center of the cluster. The points are then assigned to the new centroids. The process continues until no change occurs between iterations. Alternatively, a threshold change can be set, where it could be used to determine an end point. At step 312, centroids may be used to detect new and outlying transactions and label them as “bad” cases or score accordingly. As an output of an anomaly detection algorithm, two possibilities exist. First, a label can be used as a result indicating whether an instance is an anomaly or not. Second, a score or confidence value can be a more informative result indicating the degree of abnormality. For supervised anomaly detection, a label may be used due to available classification algorithms. For unsupervised anomaly detection algorithms, scores are more common. In a non-limiting embodiment of the present invention, the scoring system ranks anomalies and only reports the top anomalies to the user, including one or more groupings (e.g., the top 1%, 5%, or 10%). In this way, scores are used as output and rank the results such that the ranking can be used for performance evaluation. Rankings can also be converted into a classification label using an appropriate threshold. With reference now to FIG. 3B, the result of clustering and plotting of a cluster analysis algorithm are shown. The diagram includes three clusters, with outliers existing outside the edges of the cluster, highlighted by the outlines.

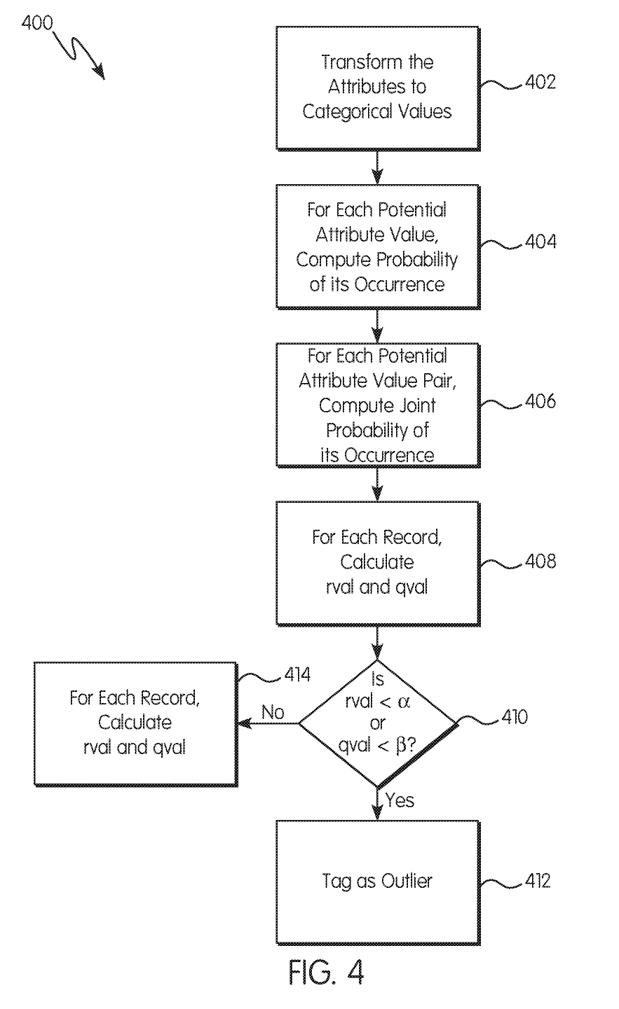

With reference to FIG. 4, a process flow diagram for unsupervised anomaly detection is shown according to a non-limiting embodiment. A performance tagging server at step 402 may further transform the attributes of transaction records to categorical values. In a non-limiting embodiment, the data is comprised of normalized records and at least one anomalous record. A likelihood model is built using the training data and a record is tested against it to determine if it is an outlier.

Transaction groups are formed by attribute and then compared for finding anomalies. In a non-limiting embodiment, the MCC, which is an attribute of all transactions, is used to categorize the transactions. For example, Table 2 illustrates the transactions arranged in MCC groupings, the membership count for each MCC group, and a probability of occurrence for each MCC category. Of the total transactions, 1,145,225 are associated with an MCC of 5812. In another example, Table 3 shows the transaction records arranged as categories based on the amount billed. For example, 3,464,982 had transactions in the spending range of $25 or less.

TABLE 2

| MCC | Counts | Probability |
|---|---|---|
| 5812 | 1,145,225 | 0.148 |
| 5814 | 913,970 | 0.118 |
| 5542 | 666,499 | 0.086 |
| 7011 | 627,067 | 0.081 |
| 4511 | 493,285 | 0.064 |
| 6011 | 375,351 | 0.048 |
| 3001 | 294,514 | 0.038 |

TABLE 3

| Bill Amt $ | Counts | Probability |
|---|---|---|
| 0-25 | 3,464,982 | 0.446 |
| 25-75 | 1,478,368 | 0.190 |
| 75-250 | 1,194,569 | 0.154 |
| 250-500 | 736,234 | 0.095 |
| 500-1K | 602,487 | 0.078 |
| 1K-2K | 290,281 | 0.028 |

Still referring to FIG. 4, at step 404, for each potential attribute value pair, the method computes a probability of its occurrence. For example, Table 2 shows the probability of each MCC occurring. The probability or the likelihood of MCC ‘5812’ may refer to the number of transactions having the ‘5812’ attribute out of the total number of possible outcomes (e.g., the total number of all transactions having an associated MCC). At step 406, for each potential attribute value pair, a joint probability of occurrence is generated. For example, an MCC of 5812 and a billing range of $25 or less is an example of a potential attribute value pair. In such an attribute value pair, the transaction satisfies the request for both conditions of the occurrence to be true. The probability may then be calculated for the combination, i.e., 0.091. The count of records for this attribute value pair is 703,542 having an MCC of 5812 and a billing range of $25 or less. For each attribute value pair, the determined result is stored.

Still referring to FIG. 4, at step 408, the joint probability of attributes and rarity of an attribute value or combination is determined. The “r value”, rval, defines the joint probability of attribute values Xᵢ and Yᵢ for record i occurring together divided by the probability that each attribute value may be occurring independently. The “R value” may be defined by:

$$rval ( {X}_{i} , {Y}_{i} ) = \frac{P ( {X}_{i} , {Y}_{i} )}{{P ( {X}_{i} )}^{*} P ( {Y}_{i} )}$$

Where,
X, Y=set of attributes/features,

P(Xᵢ)=P(X=i).
The ‘Q value’ calculates the rarity of occurrence of an attribute value:

qval(Xᵢ)=ΣₓₑₓP(x) where X={x:P(x)<=P(Xᵢ)}

At step 408, it is determined whether rval<α or qval<β. In a non-limiting embodiment, the threshold values (α=0.01, β=0.0001) are provided to compare with the rval and qval of a transaction. Transaction 1 is not an outlier because the threshold value is not met:
Transaction 1: MCC=5812, Billing Amt=‘0-25’ Count(MCC=5812 & Billing=0-25)=703,542 P(MCC, Billing)=0.091, rval=1.38>α
   Transaction 2 is an outlier because the threshold is met:
Transaction 2: MCC=5812, Billing Amt=‘500-1 K’ Count(MCC=5812 & Billing=500-1 K)=870 P(MCC, Billing)=0.00011, rval=0.0098<α

At step 410, if the threshold comparison is true, then the matching record(s) is tagged as an outlier, or scored according to the determination. If not, the system returns to the next record for processing until rval and qval are calculated for each record.

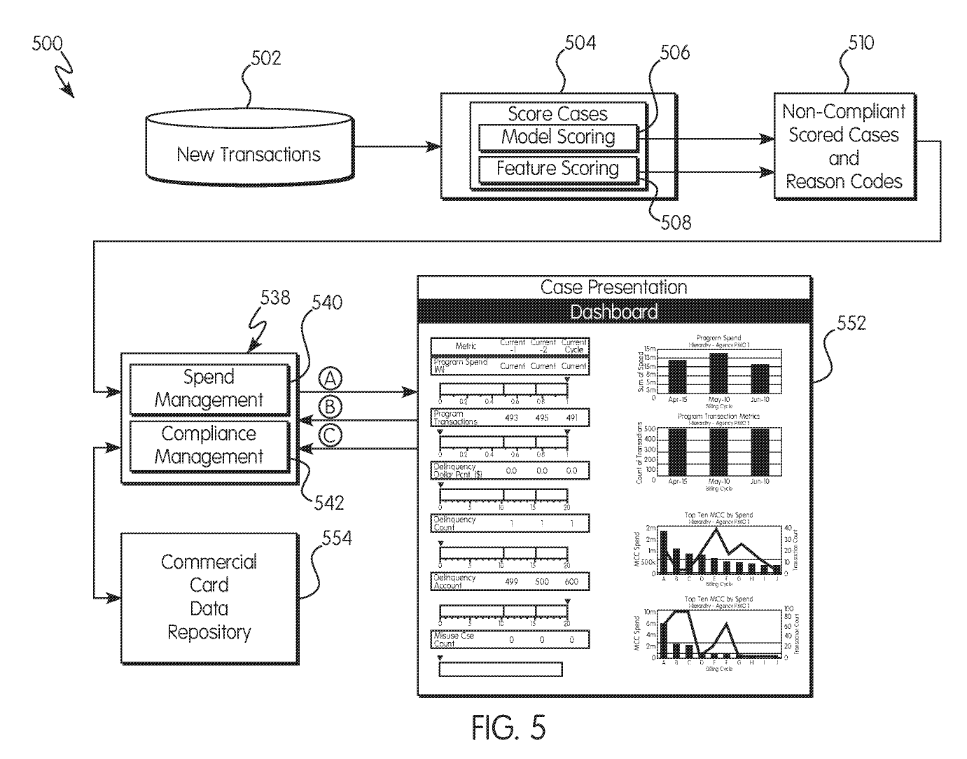

With reference to FIG. 5, a schematic diagram for a system for processing and reviewing at least one scored non-compliant commercial card transaction is shown according to a non-limiting embodiment. A case management system 500 receives new transactions 502 into a tree traversal algorithm 504 for model scoring 506 and feature scoring 508. In some embodiments, a commercial card case management system 500 may be one or more separate computer systems executing one or more software applications. During compliance determination, transactions are separated into compliant and non-compliant cases, which are communicated or stored for later use. A presentation server 538 receives transactions, including one or more non-compliant cases for review and disposition tagging. In a non-limiting embodiment, the case presentation system 538 includes a spend management processor 540 and compliance management processor 542. The case presentation server 538 can include programming instructions for serving information to administrators about the non-compliant cases in a format suitable for communicating with client devices. It will be appreciated that a number of different communication protocols and programming environments exist for communicating over the internet, wide and local area networks, and one or more mobile devices or computers operated by a reviewer, manager, administrator, and/or financial coordinator.

Still referring to FIG. 5, the case presentation system 538 includes a spend management processor 540 to provide out-of-compliance transactions with, for example, one or more of annotations, alerts, past due accounts, monitored spending to detect overages, approval threshold triggers, preferred supplier designations, and regulatory reporting. The spend information uses multi-source data to provide a holistic view of spend information and drives increased operational efficiency and savings, as well as improved control and compliance with commercial card policies enacted by the company. A dashboard 550 for a non-limiting embodiment is shown having an exemplary case presentation display. Data provisioning queries calculate metrics for the dashboard associated with how cardholders are spending. The system is used by reviewers, managers, and administrators to correct commercial card misuse and abuse. Spending guidelines may be entered and used to stop behaviors identified as misuse or abuse. The system may also be used to consolidate spending with preferred suppliers.

The compliance management processor 542 for auditing and presenting non-compliant transactions presents the scored non-compliant cases for tagging after scoring with the dynamic score rules, compliance workflow, and self-adaptive feedback. The compliance system adds a layer of protection and control for commercial card programs. In one aspect of the invention, the compliance management processor 542 includes a dashboard that is used to provide metrics, e.g., a macro view of certain performance factors. Compliance management processor 542 also includes displays for the selection and updating of records during auditing. For example, an audit of non-compliant transactions can be sorted by at least one or more of consumer demographic details, merchant details, or supplier details. For example, in a non-limiting embodiment, fields used to perform an audit may include one or more of MCG, MCC, airline identifier, hotel chain identifier, car rental identifier, supplier address, cardholder country, transaction type, amount, total spend, percent of spend, transaction counts, delinquency dollars, count, amounts, misused case count, type, and/or spend. In addition, non-compliant cases may be audited by a threshold percent, such as top ten MCC by spend or some other threshold. The merchant profile may be defined by frequency of transactions across the company or other groupings. Transaction geography may define purchases at locations never previously visited or infrequently visited by any employee that may identify or influence identifying a settled transaction. Transaction values may also define deviant measures for evaluating whether a transaction is anomalous to a card program level. Transaction velocity and splitting may include, for example, a high value purchase that is split into multiple transactions to game the system or high velocity ATM withdrawals. Detailed level data may define lodging transactions, with a detailed breakdown to levels and/or subcategories within lodging transactions, such as gift store, movie, telephone, minibar, or cash advance purchases.

The compliance management processor 542 provides an interface for scored commercial transaction case review. The case presentation system communicates existing case dispositions (B) and score influencing rules (C) to the compliance management processor 542 which further communicates the feedback to the data repository for storage until refinement of the score rules. In an embodiment of the invention, the compliance management processor 542 provides additional data manipulation on the interface 550 for activating at least one new or updated score influencing rule, sampling, or prediction processes to identify questionable transactions to be processed through the compliance management processor 542. Sampling statistics may refer to a sampling of results to define conditions for handling a case. The score influencing rules may refer to stored logic for comparing a transaction against criteria set in one or more standard rules, set of rules, or customizable rules to identify potential out-of-policy spend. Case disposition data may define a transaction or grouping of transactions, for example, including at least one of misuse, abuse, fraud, or valid.

The compliance management processor 542 receives input including, for example, one or more non-compliant scored cases for constant surveillance to help identify misuse and abuse updates and to provide those updates into the rules in the dynamic scoring system. The compliance processor also provides an intervention algorithm to automatically monitor specified card programs and provide suggestions for updates to move the program closer or back into compliance. In an aspect of the invention, the interface 550 may be a web-based, flexible application for commercial payment programs for maximization of savings and benefits by operating according to a company's policies.

The processed data flows may be displayed or presented in the case presentation's interface 550. The review is initiated in the first step by a manager in the compliance case management system 538. Next, appropriate personnel may respond to the initiated case, to clarify aspects of the case, for example, receipts may be required for a questioned transaction. The case is reviewed and accepted or rejected in response. Final disposition information is provided when the case is closed and placed into a configuration file.

The supervised learning may leverage attributes to influence scores. For example, the score influencing rules can include one or more attributes or influencing adjustments. Card profile characteristics may determine the expected transaction behavior defined by related historical transactions. Score influencing may be defined using attributes of the record, including by company title and hierarchy level adjustments (e.g., CEO, VP, and engineer).

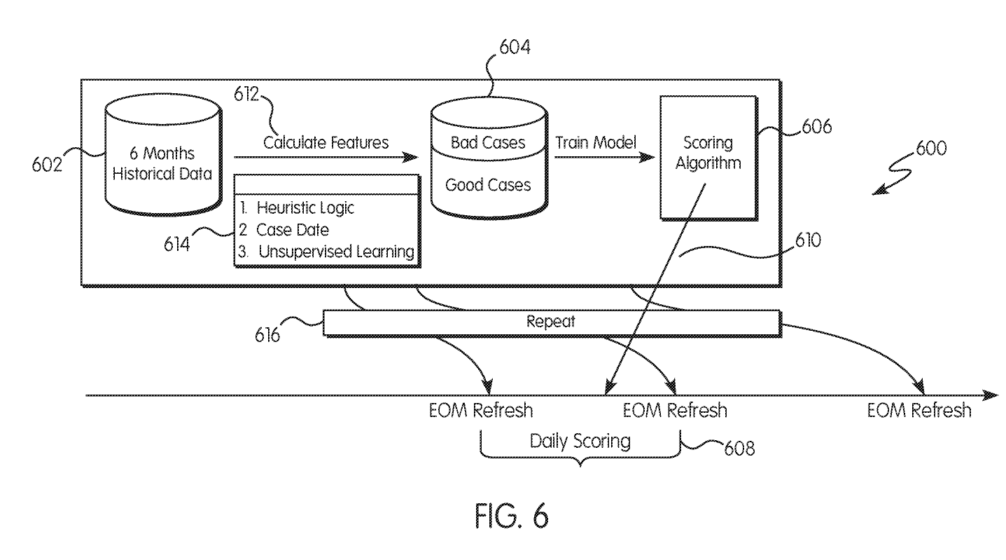

With reference to FIG. 6, a schematic diagram for a monthly model fitting system 600 shows the model fitting processing over a predetermined period of time according to a non-limiting embodiment. In embodiments, a refresh rate is predetermined, causing a database 602 to refresh every month (or other time period) by communicating historical data for model fitting and calculating features. During the model fitting, the case dispositive matrix and score influencing rules are executed on the dataset to remove all known misuse and abusive cases. The data stores may include, for example, one or more data collections, such as finance, travel, ecommerce, insurance, banking, recreation, and hospitality, and hold transactional data for machine learning. Months or years worth of commercial card transactions and related data can be stored and combined to form a basis for the prediction system operations. It will be appreciated that the refresh rate may be any period of time.

In non-limiting embodiments, at least six months of historical data is used to perform the model scoring. Some of the data may be data labeled with classification labels, comprising features, disposition data, heuristic logic, case data, and unsupervised score rules. Other data may be in a raw format, with no tagging or classification. The anomalies are derived from the datasets, which include compliant cases and one or more non-compliant cases.

In addition to historical data, other sources of data are used for anomaly detection. Case data is defined by and associated with supervised learning about each company or institution. In an aspect of the invention, each company or institution will have the capability for including score values based on certain criteria. For example, the case data may indicate a low score for an MCC of 5812 and an amount less than $5. In another example, a commercial card associated with a CEO of a commercial cardholder company may be configured to suppress any amount less than $50k. In another non-limiting example, when a company that does business across industries identifies commercial card holders purchasing from an ecommerce company, the transaction may be scored to indicate it as misuse. To detect this type of probable misuse, a rule can be added to flag all such transactions based on the MCC of the transaction under a supervised learning model. Alternatively, machine learning algorithms may be used to detect such anomalies. In yet another example, any adult entertainment commercial transaction during a hotel stay may be identified as misuse.

In a non-limiting embodiment, the transactions are each tagged (e.g., labeled) as ‘good,’ ‘misuse,’ ‘abuse,’ and/or ‘fraud.’ Commercial cards that are used to make weekend purchases may be tagged as probable abuse and/or misuse. Scoring rules are stored in configuration files and processed in association with the model data. The configuration file may be executed when the data services are provisioning the modeling data before the performance tagging using machine learning or on each transaction as it arrives. In this way, obsolete data is removed from the system before the machine learning algorithms are run. This limits the effect that known old cases could otherwise have on the learning process. Such rules can be used to eliminate transactions from the modeling dataset or can be used to adjust the impact to influence the score of cases before the performance tagging acts on the data.

In a non-limiting embodiment, and with continued reference to FIG. 6, a group of candidate features is defined based on normalized transactional data, lodging data, case data, rules data, account level aggregates, transaction history, and/or balance data. At step 604, the features of the data are calculated using processes for unsupervised machine learning. The model scoring training builds a scoring algorithm using gradient boosting trees with reason codes for estimating the feature importance in each tree. The term “reason code” may refer to a code, phrase, or narrative that identifies which features of an entity were the cause of the classification of that entity. For example, a classification system may assign a “fraudulent” classifier to a particular transaction, and the reason code for that classification may identify the “transaction amount” and “address verification” features as being the reason for that classification. The reason code may also include more detailed information, such as the conditions for each respective feature that caused the classification. For example, the reason code may indicate that the transaction was classified as “fraudulent” due to the transaction amount being larger than a specified threshold and the address not being verified. The estimated feature contribution in the scores of each terminal node generates the reason codes. At step 606, the model is trained using the input dataset and uses the algorithms to build a data model.

Still referring to the non-limiting embodiment in FIG. 6, at step 608 scoring occurs every 24 hours or at any predetermined time interval. New scoring data updates the scoring efficiency, quality, completeness, and speed. The case data, the unsupervised learning algorithms, and the heuristic logic are received. The program stores a sample weight to adjust the sample to the population weight in an embodiment of the invention.

The tables below show the results of comparing a legacy system with non-limiting embodiments of the new self-adaptive dynamic scoring system described herein. The system-wide quantitative results illustrate the significant increase in accuracy. The cross-company aggregated data shows much higher detection in both the top 5% and 10%. The “Bads” are the cases that are are ultimately labeled as ‘misuse,’ ‘abuse,’ and/or ‘fraud.’

TABLE 4
New Score

| Cumulative % | Cumulative | Cumulative % | Bad- |
|---|---|---|---|
| Accounts | # Bads | Bads | Rate |
| Top 5% | 418 | 77% | 4.74% |
| Top 10% | 458 | 84% | 2.59% |
| 100% | 546 | 100% | 0.31% |

TABLE 5
Old Score

| Cumulative % | Cumulative | Cumulative % | Bad- |
|---|---|---|---|
| Accounts | # Bads | Bads | Rate |
| Top 5% | 101 | 18% | 0.90% |
| Top 10% | 152 | 84% | 0.86% |
| 100% | 546 | 100% | 0.31% |

Tables 4 and 5 show the difference in results between two scoring systems, table 4 using the new scoring model generation and the other not using such scoring methods. Table 4 shows the accuracy increasing significantly as risk for accounts increases among the riskiest groups as compared to the same groups in the old system. For example, the bad-rate in the top 5% of riskiest accounts is 5× better using the new scoring than those using the old scores. These rates are increased for a high percentage of the riskiest cases based on the unsupervised learning algorithms. Below, table 6 and 7 further divide the riskiest 1% to exemplify coverage, the probability that the scoring will produce an interval containing a bad case. Coverage is a property of the intervals. Table 6 shows probabilities with coverages for the top 1%, with a further division of this group in Table 7. The coverage in in the top 5% is 4× better with the new scoring than the old scoring.

TABLE 6
Top 1% Statistics for New Score

| Cumulative % | Bad- | Odds | |
|---|---|---|---|
| Accounts | Rate | Ratio | Coverage |
| Top 1% | 18.5% | 4.4:1 | 59.3% |

TABLE 7
Top 1% divisions

| Cumulative % | Bad- | Odds | |
|---|---|---|---|
| Accounts | Rate | Ratio | Coverage |
| 0.2 | 64% | 1:2 | 41% |
| 0.4 | 39% | 1.5:1 | 51% |
| 0.6 | 29% | 2.5:1 | 56% |
| 0.8 | 22% | 3.5:1 | 57% |
| 1.0 | 18% | 4.5:1 | 59% |

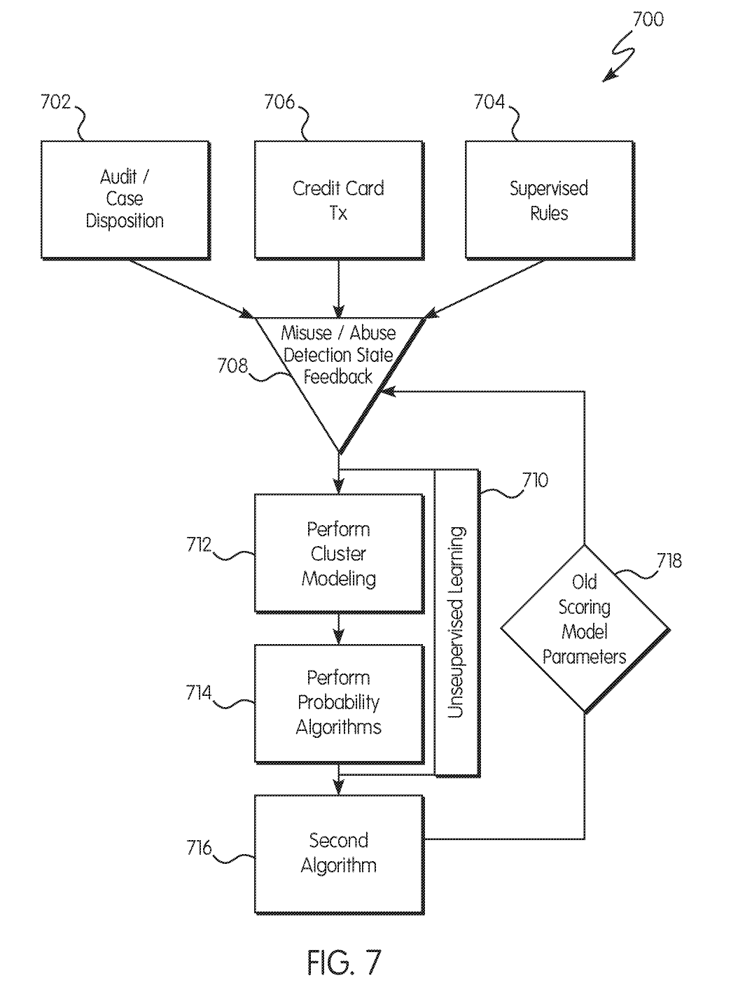

Referring now to FIG. 7, a process flow diagram 700 is shown for detecting misuse and abuse of commercial card transactions from a plurality of commercial card settled transactions associated with a plurality of merchants according to a non-limiting embodiment. It will be appreciated that the steps shown in the process flow diagram are for exemplary purposes only and that in various non-limiting embodiments, additional or fewer steps may be performed. The method 700 starts with received transaction data from several different sources, including settled transactions, supervised learning, and audit results. An audit or review is performed to make a case dispositive label for a transaction at step 702, the audit provides user or expert input into the method 700, and the case presentation server previously discussed may display an interface that defines input fields for updating a self-adapting case presentation system. The input may include, for example, data related to a case, such as changing status information about a case to ‘good,’ ‘misuse,’ ‘abuse,’ and/or ‘fraud’. The updates also include data related to a review of cases flagged by the scoring rules. For example, a company policy administrator may use a review application to tag cases scored high, e.g., top %1, by the unsupervised learning algorithms. During the review, the administrator may input judgments about the transaction for scoring which may be used in the next round to modify, refine, or create new features of the scoring rules. The tagging may be case dispositive data, including, for example, one or more tags indicating misuse, abuse, fraud, or valid.

At step 704 of FIG. 7, the compliance processor updates supervised rules. For example, the system may update a historical dataset with statements about cases for score influencing rules. In embodiments, a user enters at least one score influencing rule to adjust a score lower, higher, or in other ways (e.g., when a transaction is based on a common pattern). Score influencing rules may refer to specific company data or be applicable only to a specific set of transactions. The score influencing rules are stored in configuration files.

At step 706 of FIG. 7, data inputs, including at least, one or more settled transactions, may be received in a computing system for generating scoring rules. The data inputs may include, in addition to the subject transaction information, related historical data associated with commercial card accounts, including one or more of: historical transaction information, invoice information, and/or posted information for one or more commercial credit card accounts. The received inputs may include current transactional authorization requests associated with a current cardholder or a new cardholder.

Still referring to FIG. 7, at step 708 the model data is defined by an adapted transactional dataset provisioned with historical data to transform a transactional record. The generation of a modeling dataset for detection of anomalies is further based on feedback from supervised score influencing and case dispositive configurations, in addition to the transactions that are all received, at step 708. The supervised data is then applied to the provisioned historical and/or transactional data, using database services. The dispositive data may further refine the dataset with labels (e.g., tags) stored as attributes of a recorded transaction. The score influencing rules generate adjusted scores for a record that can be used to group records as either good or bad, for example. The scoring model receives this data, including at least some state feedback from the old scoring model, scoring the dataset before anomaly detection occurs. As a result, the feedback may include any information new to the system, as well as information about what has changed between iterations. Such information may be associated with any dimension, attribute, or segment of the data. The model scoring uses attributes of compliant cases to find new anomalies.

With continued reference to FIG. 7, the system uses a combination of unsupervised learning algorithms to create a scoring model by training a dataset with a predictive model for detecting anomalies at step 710. The anomalies are discovered using unsupervised machine learning. The machine learning algorithms, which automatically run, determine outliers and/or probabilities and likelihood based on calculated features or attributes of the historical provisioned data. The machine learning algorithm determines anomalies using a performance tagging server for automatically generating tags for a transaction based on attributes. One or more cluster modeling algorithms are performed at step 712. The clusters detect outliers in the transactional dataset defined by calculated features or attributes. The machine learning process also includes performing one or more probabilistic algorithms at step 714 for determining groupings and scoring rules based on likelihood modeling of data transactional attributes. The probabilistic algorithms define a likelihood model used in some embodiments for detecting the rarity of an occurrence based on an attribute, feature, or combination of attributes and features, and for scoring the current record against the model. The resulting features are stored and compared with the training data to form a scoring model.

The resulting features are then stored and compared with a training dataset to form a scoring model.

With continued reference to FIG. 7, a scoring model is generated based on the provisioned adapted dataset at step 716. The scoring model is applied to new transactions to give a score and an associated reason code. The scores can be used in association with similar transactions of a cardholder case. The reason codes are also associated with a scored transaction and explain the attributes that resulted in the score. The scoring phase may also identify, as reason codes, either individual features or groups of features. A user-defined list of reason codes can guide the process to further improve the quality of the resulting reason codes from a business perspective. The score is determined by the scoring model and includes calculated features or attributes. The most common patterns specific to a company or institution are scored and used for labeling cases. The scoring uses new data inputs with the scoring algorithm, with non-compliant cases scored and given at least one associated reason code explaining the reason for identifying the case as an anomaly. The activities may be associated with an account, and may cause the current settled transaction request to be denied, withdrawn, or flagged as bad.

The system is then configured to repeat the model steps at step 718, as the old scoring model is used at least once a month to refine, rebuild, or refresh the score rules with self-adaptive learning from the supervised state of the system. The feedback eliminates non-compliant cases from the normal cases and influences future unsupervised rule scores. The dataset includes at least one undetected anomaly and removes at least one previously detected anomaly, thereby increasing the probability of spotting an abusive trend in the remaining cases.

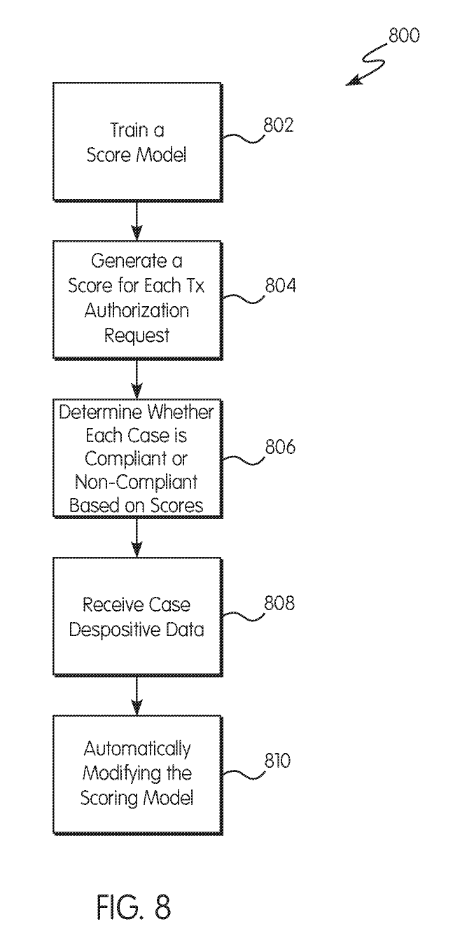

Referring now to FIG. 8, a process flow diagram is shown for generating feedback in an anomaly identification method 800 for commercial card transactions. The case presentation system receives a plurality of non-compliant scored transactions associated with a plurality of merchants. In FIG. 8, the transaction data refers to commercial card transactions that are received in the form of authorization requests or other settlement purposes. At step 802, a scoring model is trained. The model is defined by a population of input data used for determining features of the entities within the population and the relationships between the entities. To build the model, the machine learning process measures a variety of features of each entity within the population. The features of different entities may also be compared to determine segmentations. For example, an unsupervised learning process to cluster entities together according to their features and the relationships between the entities or probabilities are used to score groupings of cases and, in some instances, determining common patterns.

Next, and still referring to FIG. 8, scoring is determined for each settled transaction request at step 806. The scoring model step is used to generate the model score for a given transaction, coupled with a features' scoring step that is used to score all the features to identify the reason codes. To enable real-time scoring of both the model and the features, the system performs most of the calculations in advance. In this manner, the system operates in two-phases. The available transactions used to train the scoring models are also used to estimate the relative importance of each feature in each tree in the gradient boosting model. This may be determined only once and it may be done offline. In the second phase, when a new transaction is scored, the trees are traversed to find the final score. Simultaneously or substantially simultaneously, a separate score for each feature is updated during the process of traversing the trees. The output of this phase will be the model score, as well as a score for each feature in the model. The features' scores are ranked and the top-K features are reported as the reason codes. As an optional step, the proposed solution can perform additional steps such as feature grouping or/and feature exclusion to customize the reason codes for a particular use case and better fit a user's needs.

In the scoring step 806, a supervised machine learning process can use a set of population data and associated tags for each object in the training data and generate a set of logic to determine tags for unlabeled data. For example, a person may report that a particular transaction is “fraudulent” or “not-fraudulent.” The score influencing rules can include one or more attributes or influencing adjustments related to card profile characteristics that may determine the expected transaction behavior defined by related historical transactions. Score influencing may be defined using attributes of the record, including by company title and hierarchy level adjustments (e.g., CEO, VP, and engineer). Scoring step 806 also includes performance or automatic tagging (e.g., labeling) of the raw data based on detected anomalies in an unsupervised machine learning process. Performance tagging may be defined as automatic machine or computer-implemented tagging of records without human intervention. Performance tagging may further transform the attributes of transaction records to categorical values. For example, in a first transaction a record is determined to not be an outlier because the threshold value is not met. Accordingly, a score or disposition can be assigned for categorizing the record based on the identified feature score. Alternatively, when a threshold value is met in one or a combination of a record's attributes, a field in the record may be labeled as an outlier, for further characterizing the record. If something is scored high using performance tagging, an administrator review and score the performance tag as incorrect to make the score lower, and effect the unsupervised scoring in the next update of the scoring model.

With continued reference to FIG. 8, at step 808, the system receives case dispositive data. The modeling dataset communicates to the performance tagging server compliant cases that are labeled with additional information and non-compliant cases which are raw and not labeled. The configuration files are based on inputs during a compliance review session. The configuration files may include, for example, one or more of case dispositive information and pre-configured rulesets. These supervised learning labels and rules may define or refer to policies for using the system. For example, each company using the system can have separate influencing rules based on certain criteria. For example, if the MCC is 5812 and the threshold amount is less than $5, the score would be low, compliant, or good. In another company, the amount may be $10. For example, if the amount was $100, the score could be much higher, thus labeling the record as possible misuse and abuse.

At step 810, the system automatically modifies the scoring model. In a non-limiting embodiment, the system makes use of the known and available misuse and abuse data to learn using unsupervised machine learning algorithms to find new patterns and generate more accurate reason codes. The scores and codes become more accurate when the self-adapting feedback is used to make new determinations by identifying categories of good and bad cases with case dispositive data and influencing scoring with new rules. The self-adaptive refresh causes the scoring algorithm to predict new anomalies.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for detecting non-compliant commercial card transactions from a plurality of transactions associated with a plurality of merchants, comprising:
receiving, with at least one processor, a plurality of settled transactions for commercial cardholder accounts;
generating, with at least one processor, at least one score for each settled transaction of the plurality of settled transactions as each settled transaction is scored based at least partially on at least one scoring model;
determining, with at least one processor, whether each settled transaction is compliant or non-compliant based at least partially on the at least one score for each settled transaction;
receiving, with at least one processor from at least one user, case disposition data corresponding to at least one settled transaction of the plurality of settled transactions; and
automatically modifying, at predefined intervals, the scoring model based at least partially on heuristics, anomaly detection, and case disposition data.

2. The computer-implemented method of claim 1, wherein the at least one scoring model is based at least partially on at least one of a probability-based outlier detection algorithm and a clustering algorithm.

3. The computer-implemented method of claim 1, wherein receiving the case disposition data comprises:
generating at least one graphical user interface comprising at least a subset of the plurality of settled transactions; and
receiving user input through the at least one graphical user interface, the user input comprising the case disposition data.

4. The computer-implemented method of claim 1, wherein generating the at least one score for each settled transaction of the plurality of settled transactions as each settled transaction is received comprises generating the at least one score for a subset of settled transaction s on a daily basis or on a real-time basis.

5. The computer-implemented method of claim 1, further comprising receiving, with at least one processor from the at least one user, at least one score influencing rule corresponding to at least one settled transaction of the plurality of settled transactions, wherein the scoring model is modified based at least partially on the at least one score influencing rule.

6. The computer-implemented method of claim 5, further comprising receiving by a case presentation server the score influencing rule, wherein the score influencing rule is assigned to a first company.

7. The computer-implemented method of claim 1, further comprising in response to generating at least one score for each settled transaction, determining, with at least one processor, reason codes representing information about a particular scored feature.

8. The computer-implemented method of claim 7, further comprising in response to generating at least one score for each settled transaction, determining with at least one processor, reason codes that represent information about a particular scored feature, wherein a contribution to the score is indicated by the reason code.

9. The computer-implemented method of claim 2, wherein the clustering algorithm is processed before the at least one probability-based outlier detection algorithm, providing at least one scored settled transaction.

10. The computer-implemented method of claim 2, further comprising receiving feedback for model scoring, the feedback including at least one of the following: score influencing rules, case dispositive data, old model scores, new historical data, or any combination thereof.

11. The computer-implemented method of claim 10, wherein the feedback updates at least one attribute associated with a scored transaction.

12. A system for detecting at least one non-compliant commercial card transaction from a plurality of transactions associated with a plurality of merchants, comprising at least one transaction processing server having at least one processor programmed or configured to:
receive, from a merchant, a plurality of settled transactions for commercial cardholder accounts;
generate at least one score for each settled transaction of the plurality of settled transactions as each settled transaction is received based at least partially on at least one scoring model;
determine whether each settled transaction is compliant or non-compliant based at least partially on the at least one score for each settled transaction;
receive, from at least one user, score influencing heuristics corresponding to at least one settled transaction of the plurality of settled transactions;
receive, from at least one user, case disposition data corresponding to at least one settled transaction of the plurality of settled transactions; and
automatically modify, at predefined intervals, the scoring model based at least partially on the heuristics and case disposition data.

13. The system of claim 12, wherein the at least one processor is further programmed or configured to score the at least one model based at least partially on at least one of a probability-based outlier detection algorithm and a clustering algorithm.

14. The system of claim 12, wherein the at least one processor is further programmed or configured to:
generate at least one graphical user interface comprising at least a subset of the plurality of settled transactions; and
receive user input through the at least one graphical user interface, the user input comprising the case disposition data.

15. The system of claim 12, wherein the at least one processor is further programmed or configured to generate at least one score for each settled transactions of the plurality of settled transactions as each settled transaction is received, comprising generating the at least one score for a subset of settled transactions on a daily basis or on a real-time basis.

16. The system of claim 12, wherein the at least one processor is further programmed or configured to receive, from the at least one user, at least one score influencing rule corresponding to at least one settled transaction of the plurality of settled transactions, wherein the scoring model is modified based at least partially on the at least one score influencing rule.

17. The system of claim 12, wherein the score influencing rule is assigned to a first company.

18. The system of claim 12, wherein the at least one processor is further programmed or configured to in response to generating at least one score for each settled transaction, determine, reason codes that represent information about a particular scored feature, wherein a contribution to the score is indicated by the reason code.

19. The system of claim 12, wherein the at least one processor is further programmed or configured to process the clustering algorithm before at least one probability-based outlier detection algorithm is processed, providing at least one scored settled transaction.

20. The system of claim 12, wherein the at least one processor is further programmed or configured to include at least one or more of the following: score influencing rules, case dispositive data, old model scores, new historical data, or any combination thereof.

21. The computer-implemented method of claim 12, wherein the feedback updates at least one attribute associated with a scored transaction.

22. A computer program product for processing non-compliant commercial card transactions from a plurality of transactions associated with a plurality of merchants, comprising at least one non-transitory computer-readable medium including program instructions that, when executed by at least one processor, cause the at least one processor to:
receive, from a merchant point of sale system, a plurality of settled transactions for commercial cardholder accounts;
generate at least one score for each settled transaction of the plurality of settled transactions as each settled transaction is received based at least partially on at least one scoring model;
determine whether each settled transaction is compliant or non-compliant based at least partially on the at least one score for each settled transaction;
receive, from at least one user, score influencing heuristics corresponding to at least one settled transaction of the plurality of settled transactions;
receive, from at least one user, case disposition data corresponding to at least one settled transaction of the plurality of settled transactions; and automatically modify, at predefined intervals, the scoring model based at least partially on the heuristics and case disposition data.
